(19) United States
(12) Patent Application Publication
(10) Pub. No.: US 2005/0279902 A1
(43) Pub. Date: Dec. 22, 2005

(54) Object holder with adjustable engagement jaws

(76) Inventor: Harald Richter, Engelbrand (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 10/870,995

(22) Filed: Jun. 21, 2004

(51) Int. Cl. B23Q 3/08

(52) U.S. Cl. 248/316.4

(57) ABSTRACT

In an object holder for supporting an object such as a minicomputer, including a support plate structure with a support surface, two jaws supported on opposite sides of the support plate structure so as to be movable relative to each other for adjusting the distance therebetween, and stop fingers extending from the support plate structure at one end of the support surface thereof, each of the jaws is height adjustable and provided with a slide member, which is slidably supported on the jaws so as to be movable along a path which is parallel to an edge of the support plate structure for permitting an adjustment of the engagement area between the object and the jaws.

### BACKGROUND OF THE INVENTION

The invention relates to a holder for articles mini-computers for example Personal Digital Assistants (PDA's), or similar devices such as navigation apparatus, mobile telephones.

Such article holders are generally known. They are often supported by a support structure, for example, a flexible arm or a joint mechanism so that they can be adjusted by the user to a convenient, generally inclined position. They comprise a plate structure, which forms a support surface for the object to be supported and which has, at its end which is lower in the use positions of the device, support fingers for supporting the object at the lower end thereof. In addition, clamping jaws are provided at opposite sides of the plate structure which are spring loaded for engaging the article at opposite sides thereof. The plate structure is a flat hollow component which accommodates within the guide and operating mechanism for the engagement jaws which permits the opening of the jaws for the deposition and the removal of the article and for the engagement of the object for firmly holding the article in position on the plate structure.

These article holders are mainly used in vehicles for supporting various apparatus which the user often carries along outside the vehicle. The article holder therefore should be universally usable that is, it should be capable of supporting and engaging different types of articles and articles made by different manufacturers which may have different dimensions in width and also in height. They also have different cable connections, plugs and receptacles as well as different operating elements arranged at different positions along the sides of the article and they may have different thicknesses.

However, the article holders known in the art do not meet all the requirements since, in order to be capable of holding the article, the clamping jaws must be relatively wide and, furthermore, the mechanism disposed in the plate structure for operating the jaws must be appropriately supported in the plate structure and the jaws must be arranged in a selectable but otherwise firm position between the lower and the upper edge of the support plate structure.

It is therefore the object of the present invention to provide an object or article holder with an improved flexibility for the cooperation of the jaws with the side areas of an article placed into the holder such that the universal adaptability of the article holder is substantially enhanced.

### SUMMARY OF THE INVENTION

In a holder for supporting an object or article such as a minicomputer, including a support plate structure with a support surface, two jaws supported on opposite sides of the support plate structure so as to be movable relative to each other for adjusting the distance therebetween and stop fingers extending from the support plate structure at one end of the support surface thereof, each of the jaws is provided with a slide member or slide structure, which permits an extension of the jaws in a plane normal to the support plate structure for an adaptation to differently sized articles or objects to be engaged by the jaws.

In the object holder according to the invention, not only the spacing between the jaws is adjustable but also the engagement area of the jaws with the object is longitudinally adjustable along the sides of the support plate structure and also the height of the jaws is adjustable so that the object holder can be adapted to almost any object to be supported by the holder.

The invention will be described below in greater detail on the basis of the accompanying drawings.

### BRIEF DESCRIPTION OF THE DRAWINGS

FIG. 1 is a side view of the object holder according to the invention,

FIG. 2 is a side view of the object holder wherein the jaws are shown in a raised adjustment position, and

FIG. 3 is a perspective representation showing the jaws with a longitudinally slidably supported engagement element which is adjustable by hand.

### DESCRIPTION OF A PARTICULAR EMBODIMENT

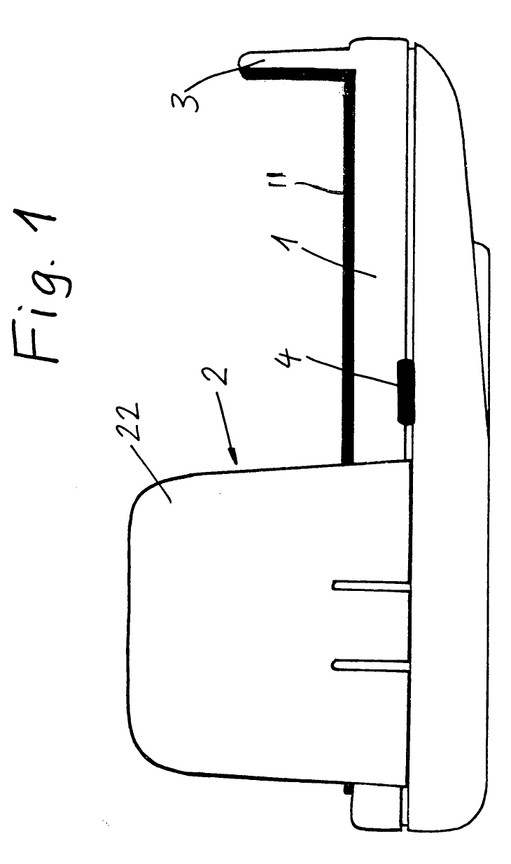

FIG. 1 shows the object or article holder according to the invention from one side thereof. It comprises a hollow support plate structure 1 with jaws 2 at opposite sides of the hollow support plate structure 1 and support fingers 3 arranged at one end of the hollow support plate structure 1 for supporting one end of an object disposed on the support plate structure 1, which is normally arranged in an inclined position such that the fingers are disposed at the lower end thereof. The hollow support plate structure 1 includes a mechanism for the synchronous movement of the jaws 2 away from, or toward, each other for adjusting the distance therebetween. This mechanism is known for example from U.S. Pat. No. 5,788,202 and therefore does not need to be described herein in detail. However, it includes an engagement mechanism and a spring mechanism, which biases the jaws 2 in an opening direction that is toward increasing the distance between the jaws 2. The jaws are moved toward each other by hand against the force of a spring and are locked in position. An operating button 4 shown in FIG. 1 at the side of the support plate structure serves as a release member for disengaging the jaws so that they can be moved apart by the spring to their fully open positions.

When an object is placed onto the support plate structure 1, the jaws are moved together manually into engagement with the object where the jaws are locked and the object is fixed. In order to engage the object safely and resiliently and to avoid rattling noises the support plate, the jaws and also the fingers may be provided with a layer of foamed rubber or a similar material.

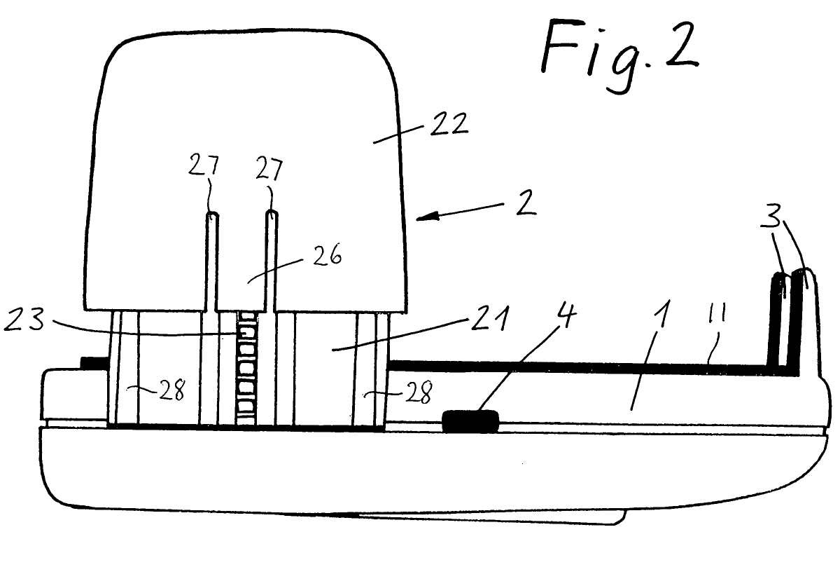

The height of the jaws 2 over the support surface 11 of the support plate structure 2 is adjustable. FIG. 1 shows the jaws 1 in the lowest fully inserted position. FIG. 2 shows the jaws in an extended position in which they project much further above the support surface 11 of the support plate structure 1.

To permit such height adjustment, the jaws 2 comprise each a base part 21 and a jaw part 22 supported by the base part 21 so as to be movable relative thereto in a direction normal to the support surface 11 of the support plate structure 1.

FIG. 2 shows also the engagement mechanism between the base part 21 and the jaw part 22 which includes a tooth structure track 23 formed on the base part 21 and a detent structure formed the engagement flap 26 for engagement by the tooth structure track. The flap 26 is made resilient by spaced parallel cutouts 27. Guide tracks 28 formed on the base part 21 guide the jaw parts 222 during raising and lowering of the jaw part 22.

Of course other engagement mechanisms could be provided for holding the jaw part 22 in a certain position relative to the base part 21.

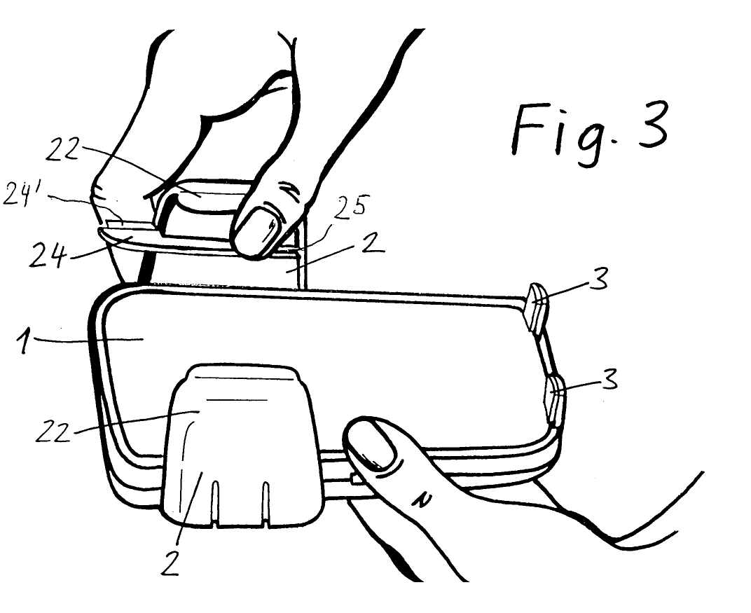

In the perspective representation of the device according to the invention as shown in FIG. 3, the inside area of the right side jaw 2 is visible. As apparent therefrom, each jaw 2 or more specifically each jaw part 22 includes at its inside a slide member 24, which is slidably supported in a groove 25 formed in the inner wall of the jaw part 22 so as to extend in the longitudinal direction of the object holder or the support plate structure 1 so that its longitudinal position relative to the support surface 11 is adjustable. In the shown exemplary embodiment, the length of the slide member corresponds to the width of the jaws but it may be longer than the jaws are wide. The slide member 24 is slidable in the groove 25 in both directions that is toward either of the ends of the support plate structure 1 in order to widen the jaw in either direction. The slide member 24 may also be moved completely out of the groove 25 in either direction. On the other hand, stops may be provided to limit the movement of the slide member 24 in the groove 25 to prevent the complete removal of the slide member 24 from the jaw part 22.

In the embodiment shown herein, the slide member 24 is a relatively narrow web with a guide flange which extends along an edge thereof which is received in the groove 24. In the embodiment shown, the slide member serves as a retaining member which prevents unwanted lifting out of the object from the support surface 11 of the support plate structure 1 and which also prevents the object from falling out of the holder during strong vibrations for example. However, the slide member may have a different shape. It may be for example, wider and/or so designed that it does not project beyond the inner jaw surface. It is furthermore possible to provide various exchangeable and differently shaped slide members for a jaw for different applications.

Instead of an embodiment, wherein the jaws 2 are provided with slide members 24 an embodiment would be possible, wherein each jaw is adjustable as a whole parallel to the edge of the support plate structure 1. That arrangement includes for each jaw a jaw carrier and the jaw carriers are supported slidably along the side edges of the support plate structure 1.

The support plate structure 1 is provided at its bottom side with mounting means for mounting the object holder onto a support arm head or a similar structure.

1. An object holder for supporting an object such as a minicomputer, comprising a support plate structure (1) with a support surface (11) for supporting the object, two jaws (2) supported at opposite sides of said support plate structure (1) so as to be movable relative to each other for adjusting the distance therebetween and stop fingers extending from said support plate structure (1) at one end of said support surface (11) and forming an engagement stop for said object when supported on said support plate structure (1), each of said jaws (2) including means for extending said jaws in a plane extending essentially normal to, and in the direction of, said support surface.

2. An object holder according to claim 1, wherein said jaws are each provided with slide members (24) which are slidably supported on said jaws so as to be movable along a path which is parallel to an edge of said support plate structure (1) for laterally extending said jaws.

3. An object holder according to claim 2, wherein said slide member (24) has a length corresponding to the width of said jaw (2).

4. An object holder according to claim 2, wherein said slide member (24) forms a web which projects from the jaw (2) on which said slide member (21) is supported toward the opposite jaw.

5. An object holder according to claim 2, wherein said slide member (24) is supported on a guide slot (25) of said jaw (2) which extends fully across said jaw (2) and said slide member (24) is slidable out of said guide slot (25) is slidable out of said guide slot (25) for removal of said slide member (24) from said jaw (2).

6. An object holder according to claim 1, wherein each jaw comprises a base part (21) which is mounted to said support plate structure (1) and a jaw part (22), which is supported on said base part (21) so as to be height adjustable.

7. An object holder according to claim 6, wherein said base part (21) is provided with guide tracks (28) and said jaw part (22) is slidably supported by said guide tracks (28).

8. An object holder according to claim 6, wherein said base part (21) is provided with a tooth structure track (23) and said jaw part (22) is provided with a resiliently supported detent structure (26) disposed adjacent said tooth structure track for retaining said jaw part (22) in a particular desired position relative to said base part (21).

9. An object holder according to claim 8, wherein said detent structure is formed between two spaced parallel slots (27) formed into said jaw part at opposite sides of said detent structure (26).
